(19) United States
(12) Patent Application Publication
(10) Pub. No.: US 2011/0200813 A1
(43) Pub. Date: Aug. 18, 2011

(54) PROCESS FOR PRODUCING THERMOPLASTIC RESIN FOAM FILM AND THERMOPLASTIC RESIN FOAM FILM

(75) Inventor: Tetsuo Okura, Osaka (JP)

(73) Assignee: KANEKA CORPORATION, Osaka-shi, Osaka (JP)

(21) Appl. No.: 13/125,448

(22) PCT Filed: Oct. 16, 2009
(86) PCT No.: PCT/JP2009/067874

§ 371 Date: Apr. 21, 2011

(30) Foreign Application Priority Data
Oct. 23, 2008 (JP) 2008-273347

(51) Int. Cl. B32B 3/26; B32B 5/00; B32B 15/08; B26D 1/00

(52) U.S. Cl. 428/220; 428/319.1; 83/13

(57) ABSTRACT

Disclosed is a process for producing a thermoplastic resin foam film that can produce a thin thermoplastic resin foam film. The process comprises the step of cutting a thermoplastic resin foam. The process is characterized in that, in the step of cutting the thermoplastic resin foam, at least one of the thermoplastic resin foam and a blade is reciprocated, and, when at least one of the thermoplastic resin foam and the blade is reciprocated, and the thermoplastic resin foam and the blade are slid in the movement of the foam or the blade on at least one of the advancement path and the return path of the reciprocation movement, whereby the thermoplastic resin foam is intermittently cut.

### TECHNICAL FIELD

The present invention relates to a process for producing a thermoplastic resin foam film and a thermoplastic resin foam film.

### BACKGROUND ART

In the trend toward reduction in size and increase in performance of portable communication terminals such as cellular phones, there is recently an increasing demand for lighter, thinner, and more rigid materials. Although such materials may be made only from a single material, layered structures consisting of a shell and core regions are considered more favorable for having balanced light weight and rigidity at higher level, and there is a demand for a foam suitable for the core region that is light, thin, and additionally higher in compressive strength.

Low-density foams of polyurethane resin have been used as thin foam films in the sealing material application, for example for sealing the display of cellular phones, and Patent Document 1 discloses a polyurethane foam having a thickness of 0.3 to 13 mm. However, such foams, which are deformable as they are held densely between two articles, are unfavorable for the core region of layered structures.

Patent Document 2 proposes a laminate foam sheet of a polyphenylene ether resin and a polystyrene resin, which is heat-shrinkable more in a particular direction and discloses a foam film having a thickness of 0.25 to 0.5 mm. However, the foam film is drawn more in the extrusion direction for increase of heat shrinkage and the cells therein are flattened significantly in the thickness direction and unfavorably lower in compressive strength.

On the other hand, thermoplastic resin foams have also been cut by processes using a band knife such as saw blade or knife blade, and Patent Document 3 discloses a cutting process by using a knife blade. However, the process described in Patent Document 3 is aimed at cutting processing without destruction of surface cells, and there is no description on production of a foam film higher in thickness accuracy. It disclosed a cutting process by using a knife blade as the cutting process, and shaving blades and band saws having knife blades are exemplified therein. When a band saw having knife blades is used for production of a thin foam film, it is not possible to obtain a foam film higher in thickness accuracy, because irregularity in thickness is generated, as a result of fluctuation (deflection) of the tension applied to the knife blades. In addition, if the knife blade is processed into a cyclic shape, the thick welded region thus formed leaves a linear cutting scratch on the cutting surface. Cutting by using a planer is also exemplified, but it is not possible to obtain a foam film thereby, as the cut foam obtained by the method are cut into small pieces.

### CITATION LIST

### Patent Literature

Patent Document 1: JP-A No. 2007-44972

Patent Document 2: JP-A No. 2-151429

Patent Document 3: JP-A No. 2002-86577

### SUMMARY OF INVENTION

### Technical Problem

An object of the present invention is to provide a thermoplastic resin foam film that can be converted into a high-rigidity laminate foam film by lamination with aluminum foil and a process for producing a thermoplastic resin foam film by cutting a thermoplastic resin foam.

### Solution to Problem

After intensive studies to solve the problems above, the inventors have found that it is possible to obtain a light and thin thermoplastic resin foam film easily. It was also found that even a light-weighted thin thermoplastic resin foam film can have a rigidity suitable for use as a structural material, if it has high compressive strength.

Specifically, the present invention consists of the followings:

(1) a process for producing a thermoplastic resin foam film, having a step of cutting a thermoplastic resin foam, characterized in that, in the step of cutting a thermoplastic resin foam, the thermoplastic resin foam is cut intermittently, as at least one of the thermoplastic resin foam and a blade is moved reciprocally and the thermoplastic resin foam and the blade are brought into contact with each other at least in the path of forward or backward movement;
(2) the process for producing a thermoplastic resin foam film according to (1), wherein, in the step of cutting a thermoplastic resin foam, a thermoplastic resin foam having a certain thickness is cut, as the thermoplastic resin foam is fed by a certain thickness and the thermoplastic resin foam and the blade are brought into contact with each other at least in the path of forward or backward movement;
(3) the process for producing a thermoplastic resin foam film according to (1) or (2), wherein the thermoplastic resin foam is cut into a thin film and the thin film is further flattened, as it is heated to a temperature in the range of the thermoplastic resin glass transition temperature −30° C. or higher and, the glass transition temperature or less;
(4) a thermoplastic resin foam film, having a density of 100 kg/m³ or more and 500 kg/m³ or less, a thickness of 0.1 mm or more and 1.0 mm or less and a compressive strength at 10% compression of 0.8 MPa or more;
(5) the thermoplastic resin foam film according to (4), having a thickness of 0.1 mm or more and 0.4 mm or less;
(6) the thermoplastic resin foam film according to (4) or (5), wherein the glass transition temperature of the thermoplastic resin is 105° C. or higher;
(7) the thermoplastic resin foam film according to any one of (4) to (6), wherein the thermoplastic resin is a styrenic resin; and
(8) a laminate foam film, comprising the thermoplastic resin foam film according to any one of (4) to (7) and an aluminum foil laminated at least on one face thereof.

### Advantageous Effects of Invention

The process for producing a thermoplastic resin foam film according to the present invention provides a thermoplastic resin foam film higher in thickness accuracy. In addition, the thermoplastic resin foam film according to the present invention is higher in compressive strength, although it is light in weight and thin. Thus, it gives a high-rigidity laminate foam film, for example when laminated with aluminum foil.

### BRIEF DESCRIPTION OF THE DRAWINGS

FIG. 1 shows an example of the results obtained by measurement with differential scanning calorimeter for determination of the glass transition temperature of a thermoplastic resin according to the present invention. The abscissa axis shows the temperature, while the ordinate axis shows the heat absorption. Approximate lines are determined in the gradually declining regions in the early and later phases after start of heating and also in the steeply declining region in the intermediate region, and the temperature at the center of the two intersections between these approximate lines is the glass transition temperature.

FIG. 2 is a schematic view of the cutting machine used in Example 1.

FIG. 3 is a schematic view of the cutting machine used in Example 4.

FIG. 4 is a schematic view of the cutting machine used in Example 5.

FIG. 5 is a schematic view of the cutting machine used in Comparative Example 4.

### REFERENCE SIGNS LIST

1 Thermoplastic resin foam

2 Blade

3 Supporting plate for feeding the foam to a certain distance

4 Rail

5 Supporting plate for fixing the blade

6 Table for carrying the foam

7 Conveyor

8 Pulley

9 Nip roll

10 Band knife

### DESCRIPTION OF EMBODIMENTS

The present invention relates to a process for producing a thermoplastic resin foam film, having a step of cutting a thermoplastic resin foam, wherein the thermoplastic resin foam is cut intermittently, as at least one of the thermoplastic resin foam and a blade is moved reciprocally and the thermoplastic resin foam and the blade are brought into contact with each other at least in the path of forward or backward movement.

In the step of cutting a thermoplastic resin foam according to the present invention, at least one of the thermoplastic resin foam and the blade is moved reciprocally and the thermoplastic resin foam and the blade are brought into contact with each other at least in the path of forward or backward movement.

Specifically, the thermoplastic resin foam may be fixed and cut by a blade moving reciprocally, or alternatively, the thermoplastic resin foam may be fixed on a supporting plate moving on a rail reciprocally and cut by a fixed blade. It is thus possible to obtain a surface-smooth thermoplastic resin foam film higher in thickness accuracy in the region close to the center, by moving at least one of the thermoplastic resin foam and the blade reciprocally and bringing the thermoplastic resin foam and the blade into contact with each other at least in the path of forward or backward movement. In addition, it is preferable, for suppression of tearing off of the thermoplastic resin foam during cutting, to make the blade inclined and not in parallel with the side of the thermoplastic resin foam during contact with the thermoplastic resin foam and to bring them first into contact with each other at a point (point contact). The angle, which is called as bias angle, is preferably 5° to 85°.

The reciprocating motion of the thermoplastic resin foam or the blade in the present invention is not limited to reciprocating motion completely along an axis. Alternatively, it may be combination of a reciprocal motion and a slightly bobbing movement, for example when the thermoplastic resin foam or the blade is connected to a crank gear.

The blade for use in the present invention is preferably not a saw blade but a knife blade for higher surface smoothness of the foam film obtained. In addition, preferably the thickness of the blade is 3 mm or more, because it is possible to avoid the deterioration in film thickness accuracy caused by deflection of the blade.

In the process of cutting a thermoplastic resin foam intermittently by moving at least one of the thermoplastic resin foam and the blade reciprocally and bringing the thermoplastic resin foam and the blade into contact with each other in at least the path of forward or backward movement, the density of the thermoplastic resin foam is preferably 100 to 500 kg/m³. A density of less than 100 kg/m³ may lead to deterioration in thickness accuracy, while a density of more than 500 kg/m³ may leads to cracking of the thermoplastic resin foam film during cutting operation.

In the process of cutting a thermoplastic resin foam intermittently by moving at least one of the thermoplastic resin foam and the blade reciprocally and bringing the thermoplastic resin foam and the blade into contact with each other in at least the path of forward or backward movement, the thermoplastic resin foam may be cut after each reciprocal movement while the thermoplastic resin foam and the blade are placed under a certain constant load, but a method of feeding the thermoplastic resin foam to a certain distance after each cutting operation and cutting the fed region of thermoplastic resin foam is preferable, because the thickness accuracy of the terminal region of the thermoplastic resin foam film is better and thus, the obtained film is usable in wider applications.

The thermoplastic resin foam for use in the process for producing a thermoplastic resin foam film having a step of cutting the thermoplastic resin foam is preferably a rectangular body foam, in particular a rectangular body thermoplastic resin foam prepared by bead foaming method, for easier modification of the thickness and the density of the thermoplastic resin foam film obtained. The method of preparing a rectangular body thermoplastic resin foam by the bead foaming method for use may be any known method. For example, a rectangular body foam can be obtained, by preparing preliminary foamed particles by heating expandable thermoplastic resin particles containing a foaming agent such as hydrocarbon with steam or a mixed gas of steam and air in a revolving-agitation preliminary foaming machine, and filling and heating the preliminary foamed particles thus obtained in a rectangular body mold with steam or the like. The density of the thermoplastic resin foam can be controlled easily by modification of the heating condition for preparation of the preliminary foamed particles. Examples of the thermoplastic resins include those described below.

A thin film is obtained by cutting the thermoplastic resin foam. The thin film may be used as it is as the thermoplastic resin foam film according to the present invention, but the thin film often curls in the shape of shavings, which make it difficult to handle. In such a case, it is preferable to flatten the thin film, while heating it at a temperature of the glass transition temperature of the thermoplastic resin −30° C. or higher and less than the glass transition temperature. The flattening under heat specifically means slight pressurization of the thin film on a plane surface under heat, for example by ironing or storage in a heating oven, as it is held between two planer plates.

A heating temperature lower than the glass transition temperature −30° C. may results in insufficient removal of the curling deformation, while a heating temperature higher than the glass transition temperature may result in deterioration in thickness accuracy, for example, by further expansion or collapse of the thermoplastic resin foam film. The pressurization pressure is preferably 0.1 MPa or less for prevention of collapse of the thermoplastic resin foam film.

The thermoplastic resin foam film according to the present invention has a density of 100 kg/m³ or more and 500 k/m³ or less, a thickness of 0.1 mm or more and 1.0 mm or less, and a compressive strength at 10% compression of 0.8 MPa or more.

The density of the thermoplastic resin foam film according to the present invention is 100 kg/m³ or more and 500 kg/m³ or less, preferably 120 kg/m³ or more and 300 kg/m³ or less. A density of more than 100 kg/m³ leads to insufficient rigidity of the laminate foam film when formed, while a density of more than 500 kg/m³ leads to deterioration in lightness.

The thickness of the thermoplastic resin foam film according to the present invention is 0.1 mm or more and 1.0 mm or less, preferably 0.1 mm or more and 0.7 mm or less, more preferably 0.1 mm or more and 0.4 mm or less, and still more preferably 0.15 mm or more and 0.4 mm or less. A thickness of less than 0.1 mm leads to significant deterioration in rigidity, particularly in the region of the film where the thickness is lower because of thickness irregularity, which in turn leads to deterioration in rigidity of the laminate foam film when foamed. A thickness of more than 1.0 mm leads to restriction in use of a narrow region.

The compressive strength at 10% compression of the thermoplastic resin foam film according to the present invention is 0.8 MPa or more, preferably 1.0 MPa or more. When the compressive strength at 10% compression is less than 0.8 MPa, it is not possible to obtain sufficient rigidity of the laminate foam film when formed.

For preparation of such a thermoplastic resin foam film, the thermoplastic resin used as the base material is preferably highly rigid, and examples of the thermoplastic resins include styrenic resins such as styrene homopolymers, styrene/acrylonitrile copolymers, styrene/α-methylstyrene copolymers, styrene/methacrylate copolymers, styrene/α-methylstyrene/acrylonitrile copolymers, and α-methylstyrene/acrylonitrile copolymers; modified polyphenylene ether resins such as mixtures of a styrene homopolymer and a polyphenylene ether resin, and mixtures of a styrene/butadiene copolymer and a polyphenylene ether resin; polymethyl methacrylate resins such as methyl methacrylate homopolymers and methyl methacrylate/methyl acrylate copolymers; cyclic olefin resins such as ethylene/norbornene copolymers and ethylene/dicyclopentadiene copolymers; polyolefin resins such as propylene homopolymers, propylene/ethylene copolymers, propylene/butene copolymers, ethylene homopolymer, and ethylene/butene copolymers; and the like.

In addition, the glass transition temperature (hereinafter, referred to as Tg) of the base material thermoplastic resin is preferably 105° C. or higher, because dimensional change and deterioration in rigidity are smaller even under an environment at 85° C., which is demanded for example for cellular phones, and also dimensional change during lamination, for example with an aluminum foil by using a hot melt adhesive higher in heat resistance, is smaller. Examples of the thermoplastic resins include, among the resins above, styrene/acrylonitrile copolymers, styrene/α-methylstyrene copolymers, styrene/methacrylate copolymers, styrene/α-methylstyrene/acrylonitrile copolymers, α-methylstyrene/acrylonitrile copolymers, mixtures of a styrene homopolymer and a polyphenylene ether resin, mixtures of a styrene/butadiene copolymer and a polyphenylene ether resin, ethylene/norbornene copolymers, ethylene/dicyclopentadiene copolymers, and the like.

Among the polymers above, styrenic resins such as styrene/acrylonitrile copolymers, styrene/α-methylstyrene copolymers, styrene/methacrylate copolymers, styrene/α-methylstyrene/acrylonitrile copolymers and α-methylstyrene/acrylonitrile copolymers are most preferable, because they can be easily expanded and give foams by an existing high-productivity method such as bead or extrusion foaming method.

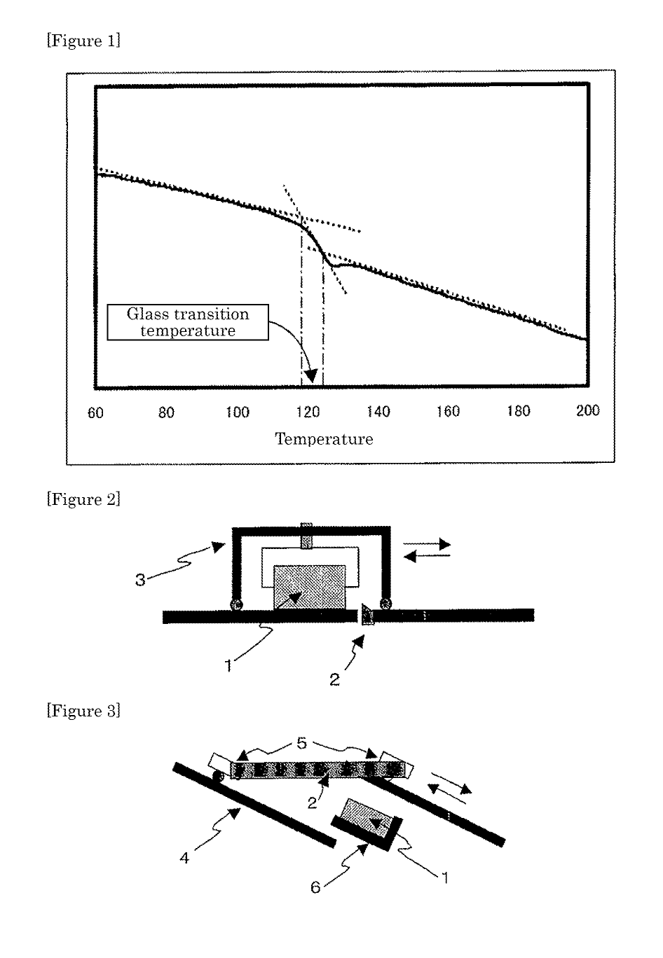

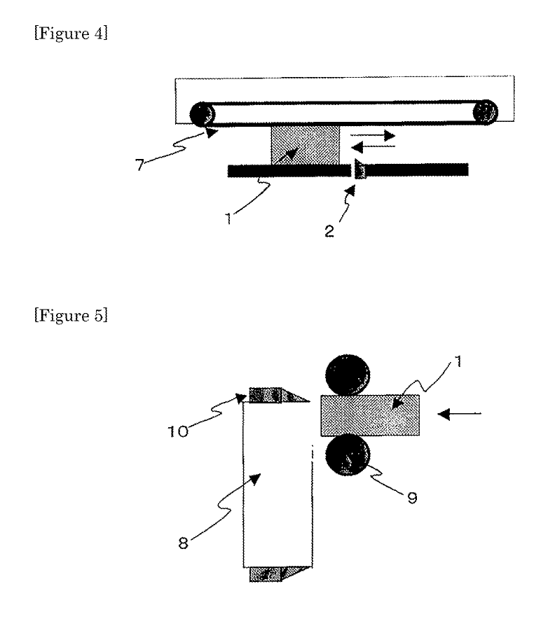

In the present invention, the glass transition temperature (Tg) of the thermoplastic resin is determined from the inflection point observed in the chart of differential scanning calorimetry (DSC), when 1 to 10 mg of a resin sample is heated from 40° C. to 210° C. at a rate of 10° C./minute, kept at the temperature for 5 minutes, cooled from 210° C. to 40° C. at a cooling rate of 10° C./minute, kept at the temperature for 5 minutes, and heated again from 40° C. to 210° C. at a rate of 10° C. /minute. A typical method will be explained, with reference to FIG. 1. The curb gradually declines toward the endothermic side when the polymer is heated, and the slope becomes steeper in the region about 110° C.; and the slope becomes gradual again in the region at about 125° C. Approximate lines (dashed lines in the FIG. 1) are drawn in the region in the early and later phases where the slope is more gradual and also in the region in the central phase where it is steeper, giving two intersections. The temperature corresponding to the center of these two intersections is called the glass transition temperature.

Examples of the processes for production of the thermoplastic resin foam film according to the present invention include an extrusion foaming method of extruding a melt resin containing a foaming agent through a cyclic or T die, a pressure foaming method of impregnating a film with a foaming agent under high pressure and then processing the film under heat or reduced pressure, a method of preparing a thermoplastic resin foam film by preparing a rectangular body thermoplastic resin foam by a bead foaming method of fusing expandable particles in a mold or by an extrusion foaming method and then cutting the rectangular body foam, and the like. The method of cutting a rectangular body thermoplastic resin foam is preferable among the methods above, because it is possible to easily obtain a thermoplastic resin foam film higher in thickness accuracy. It is still more preferable to cut a rectangular body thermoplastic resin foam obtained by the bead foaming method, because the compressive strength at 10% compression of the thermoplastic resin foam film obtained is often 0.8 MPa or more.

Since the thermoplastic resin foam obtained by the bead foaming method contains almost spherical cells, the method is advantageous for production of a thermoplastic resin foam film higher in compressive strength, as compared to the extrusion foaming method which often gives flattened cells. The method of preparing a rectangular body thermoplastic resin foam by the bead foaming method for use may be any known method. For example, a rectangular body foam can be obtained by obtaining preliminary foamed particles by heating expandable thermoplastic resin particles containing a foaming agent such as hydrocarbon with steam or a mixed gas of steam and air in a revolving-agitation preliminary foaming machine, and filling and heating the preliminary foamed particles thus obtained in a rectangular body mold for example with steam or the like. The density of the thermoplastic resin foam can be adjusted easily by modification of the heating condition for production of the preliminary foamed particles.

The present invention also relates to a laminate foam film having a thermoplastic resin foam film and an aluminum foil layered at least on one side thereof.

In the present invention, the aluminum foil to be laminated on the thermoplastic resin foam film preferably has a thickness of 0.005 to 0.05 mm, more preferably, thickness 0.01 to 0.02 mm. A thickness of less than 0.005 mm may lead to wrinkling of the aluminum foil during lamination, while a thickness of more than 0.05 mm may lead to deterioration in the advantage of light weight.

In the present invention, the method of laminating the thermoplastic resin foam film with an aluminum foil is not particularly limited, and methods of using an adhesive or a pressure-sensitive adhesive and by thermal fusion may be used, but lamination with an adhesive is preferable from the viewpoints of productivity and the thickness accuracy of the laminate composite material.

The adhesive for use in the lamination is preferably a non-solvent adhesive that is resistant to shrinkage, and examples thereof include epoxy-based adhesives, acrylic adhesives, cyanoacrylate-based adhesives, urethane-based adhesives, hot melt adhesives and the like.

### EXAMPLES

Hereinafter, the present invention will be described in detail with reference to Examples, but it should be understood that the present invention is not restricted to these Examples.

### <Measurement of the Thickness of Foam Film>

The peripheral region with a width of 30 mm was removed from a sample of 450 mm×300 mm; the thickness of the resulting sample was determined at any 30 positions by using a thickness gauge; and the arithmetic average thickness and the difference between the maximum and minimum values were calculated.

### <Measurement of the Density of Foam Film>

The length, the width, and the weight of the sample used in measurement of the thickness of thermoplastic resin foam film above were determined; and the volume was calculated from the length, the width, and the average thickness; and the density was calculated by dividing the weight by the volume.

### <Measurement of the Thickness of Foam Film in the Terminal Region>

The thickness at four corners of the sample in the peripheral terminal region, which was separated in measurement of the thickness of the thermoplastic resin foam film, was measured by using a thickness gauge, and the minimum value was used as the minimum terminal thickness.

### <Evaluation of the Compressive Strength of Foam Film>

Ten samples of 3 cm×3 cm were cut off from a thermoplastic resin foam film and piled to give a test sample; it was compressed at a rate of 1 m/min in an Autograph under an atmosphere at 23° C.; and the compressive strength at 10% compression was calculation by dividing the stress (N) at a deformation rate of 10% by the sample area (0.03 m×0.03 m=0.0009m²).

### <Evaluation of the Heat Resistance of Foam Film>

A sample of 100 mm×100 mm was cut off from the central region of the foam film; the length of each side was determined; the length was determined once again after the sample was heated in a hot air oven adjusted to 85° C.; and the rate of dimensional change was calculated by dividing the length after heating by that before heating.

### Example 1

A rectangular body foam of 450 mm×300 mm×25 mm having a density of 210 kg/m³ was prepared by preliminary expansion and molding of a heat-resisting expandable styrenic resin (low expansion ratio), Heatmax (trade name) HM5 manufactured by KANEKA CORPORATION. The rectangular foam was cut to a desired thickness of 0.3 mm by using the following cutting machine.

The cutting machine used is a wood-processing cutting machine having a supporting plate moving reciprocally on a rail in parallel with the floor face, in which a foam is cut continuously, as it is connected to the lower area of the supporting plate, reciprocated on the blade fixed facing upward for cutting, pushed downward at a desired cutting thickness after each cutting, i.e., after each reciprocation. The bias angle was set to 10°.

The thin film obtained by cutting was a film a highly curled into a roll having a diameter of about 15 mm, but, when the film is held extended between two aluminum plates, heated in a hot air oven adjusted to 110° C. for 10 minutes, and then cooled and separated, it gave a surface-smooth thermoplastic resin foam film having a density of 210 kg/m³, an average thickness of 0.30 mm, a difference between the maximum and minimum values of 0.03 mm and a minimum terminal thickness of 0.28 mm. The compressive strength at 10% compression of the foam film was 4.5 MPa; the glass transition temperature of the resin was 122° C.; and the dimensional change in the evaluation of heat resistance remained the same at 1.00.

An aluminum foil having a thickness of 0.012 mm was bonded onto both faces of the obtained thermoplastic resin foam film with an epoxy resin-based two-part adhesive (1500, produced by CEMEDINE CO., LTD.), to give a high-rigidity laminate foam film.

TABLE 1

| | | | Difference | | | | | | |
|---|---|---|---|---|---|---|---|---|---|
| | | | between | Minimum | Glass transition | Compressive | Evaluation of | | Rigidity |
| | | Average | maximum and | terminal | temperature | strength at 10% | heat resistance | | after |
| | Density | thickness | minimum values | thickness | of resin | compression | Dimensional | Evaluation | aluminum |
| | (kg/m³) | (mm) | (mm) | (mm) | (° C.) | (Mpa) | change | result | lamination |
| Example 1 | 210 | 0.30 | 0.03 | 0.28 | 122 | 4.5 | 1.00 | ∘ | ∘ |
| Example 2 | 210 | 0.70 | 0.02 | 0.68 | 122 | 4.6 | 1.00 | ∘ | ∘ |
| Example 3 | 140 | 0.30 | 0.03 | 0.27 | 122 | 2.4 | 1.00 | ∘ | ∘ |
| Comparative | 212 | 0.08 | 0.04 | 0.05 | 122 | 4.3 | 1.00 | ∘ | x |
| Example 1 | | | | | | | | | |
| Comparative | 36 | 0.31 | 0.06 | 0.28 | 116 | 0.3 | 1.00 | ∘ | x |
| Example 2 | | | | | | | | | |
| Comparative | 180 | 0.30 | 0.03 | 0.27 | 95 | 3.2 | 1.03 | x | ∘ |
| Example 3 | | | | | | | | | |

### Example 2

The rectangular foam obtained in Example 1 was cut to a desired thickness of 0.7 mm by using the same cutting machine used in Example 1 and converted into a flat film in a manner similar to Example 1. Evaluation results are shown in Table 1. Lamination of an aluminum foil having a thickness of 0.012 mm in a manner similar to Example 1 gave a high-rigidity laminate foam film.

### Example 3

A rectangular body foam of 450 mm×300 mm×25 mm having a density of 140 kg/m³ was prepared by preliminary expansion and molding of a heat-resisting expandable styrenic resin (low expansion ratio), Heatmax (trade name) HM5 manufactured by KANEKA CORPORATION, and the rectangular body foam was cut to a desired thickness of 0.3 mm and flattened in a manner similar to Example 1. Evaluation results are shown in Table 1. An aluminum foil having a thickness of 0.012 mm was bonded in a manner similar to Example 1, to give a high-rigidity laminate foam film.

### Comparative Example 1

A rectangular body foam was prepared in a manner similar to Example 1, cut to a desired thickness of 0.08 mm by using the same cutting machine used in Example 1 and flattened in a manner similar to Example 1. Evaluation results are shown in Table 1. The surface-smooth thermoplastic resin foam film thus obtained had a density of 212 kg/m³, an average thickness of 0.08 mm, a difference between the maximum and minimum values of 0.04 mm, a minimum terminal thickness of 0.05 mm. The compressive strength at 10% compression of the foam film was 4.3 MPa, and the dimensional change in the evaluation of heat resistance remained the same at 1.00, but it gave a laminate foam film smaller in rigidity, when an aluminum foil having a thickness of 0.012 mm is bonded in a manner similar to Example 1.

### Comparative Example 2

A rectangular body foam of 450 mm×300 mm×25 mm having a density of 35 kg/m³ was prepared by preliminarily foaming and molding of a heat-resisting expandable styrenic resin, Heatmax (trade name) HM manufactured by KANEKA CORPORATION, and cut and flattened in a manner similar to Example 1. The surface-smooth thermoplastic resin foam film obtained had a density of 36 kg/m³, an average thickness of 0.31 mm, a slightly large difference between the maximum and minimum values of 0.06, and a minimum terminal thickness 0.28 mm. The glass transition temperature of the foam film resin was 116° C.; the dimensional change in the evaluation of heat resistance remained the same at 1.00; but the compressive strength at 10% compression was 0.3 MPa; and it only gave a laminate foam film smaller in rigidity, when laminated with an aluminum foil having a thickness of 0.012 mm in a manner similar to Example 1.

### Comparative Example 3

A rectangular body foam of 450 mm×300 mm×25 mm having a density of 180 kg/m³ was prepared by preliminarily foaming and molding of a expandable styrenic resin, Kanepearl (trade name) HD manufactured by KANEKA CORPORATION and cut and flattened in a manner similar to Example 1. The surface-smooth thermoplastic resin foam film obtained had a density of 180 kg/m³, an average thickness of 0.30 mm, a difference between the maximum and minimum values of 0.03, and a minimum terminal thickness of 0.27 mm. The compressive strength at 10% compression of the foam film was 3.2 MPa, but the glass transition temperature of the resin was 95° C., and the dimensional change in the heat resistance evaluation was expansion at a rate of 1.03.

The results above show that the thermoplastic resin foam films of Examples were higher in heat resistance and give high-rigidity laminate foam films by lamination with aluminum foil, but a thin foam film such as that in Comparative Example 1 or a low-density low-compressive strength foam film such as that in Comparative Example 2 only give a laminate foam film lower in rigidity, and a foam film having a low resin glass transition temperature such as that in Comparative Example 3 is inferior in heat resistance.

### Example 4

The rectangular body foam obtained in Example 1 was cut to a desired thickness of 0.3 mm by using the following cutting machine.

The cutting machine used has a supporting plate moving reciprocally on a rail that was installed as inclined, and a blade that is fixed thereon at a certain angle moves in parallel in the inclined direction. It is a wood-processing cutting machine for in which a form fixed on the supporting plate is cut continuously by reciprocal movement of the blade, specifically as the foam is fed by a desired machining thickness toward the blade after each cutting i.e., after each reciprocal movement of the blade. The bias angle was set to 15°.

The thin film thus obtained was flattened in a manner similar to Example 1, to give a surface-smooth thermoplastic resin foam film having an average thickness of 0.30 mm, a difference between the maximum and minimum values of 0.03 mm, and a minimum terminal thickness of 0.28 mm.

### Example 5

The rectangular body foam obtained in Example 1 was cut to a desired thickness of 0.3 mm by using the following cutting machine.

The cutting machine used has a mechanism of pressing, in the vertical direction, the conveyor moving reciprocally in parallel with the floor; there is a supporting plate under the conveyor; a blade is fixed on the supporting plate facing upward; and the foam is held between the conveyor and the supporting plate. It is a wood-processing cutting machine for in which the foam is cut continuously, as it is moved together with the conveyor reciprocally under the force pressing the foam and pressed to the blade consistently. The bias angle was set to 15°.

The thin film thus obtained was flattened in a manner similar to Example 1, to give a surface-smooth thermoplastic resin foam film having an average thickness of 0.29 mm, a difference between the maximum and minimum values of 0.04 mm and a minimum terminal thickness of 0.17 mm.

### Comparative Example 4

The rectangular body foam obtained in Example 1 was cut to a desired thickness of 0.3 mm by using the following cutting machine.

The cutting machine used is a cutting machine for processing soft materials (such as urethane foams and cork), in which a foam is cut, as it is fed by nip rolls to the knife blade of a cyclic band knife that moves horizontally between two pulleys, and the desired cutting thickness is adjusted by modification of the width of the slit between the nip roll and the moving knife blade.

Cutting operation by the method, which left no curling deformation, gave a thermoplastic resin foam film. Only a foam film having cutting scratches on the surface and having an average thickness of 0.31 mm, a minimum terminal thickness of 0.26 mm, and a large difference between the maximum and minimum values of 0.10 mm was obtained.

In the case of the production processes of Examples 1, 4, and 5, the thickness irregularity of the foam film is smaller and the surface is smoother, as the difference between the maximum and minimum values of foam film thickness is smaller, but in the case of the process of Comparative Example 4, the thickness irregularity is larger and there is cutting scratches formed on the surface. Alternatively in the case of the processes of Examples 1 and 4, in which the foam is cut as it is fed by a certain distance after each cutting operation, there was no thickness irregularity even in the terminal region, indicating that the usable area of the film is wider.

### INDUSTRIAL APPLICABILITY

The process according to the present invention provides a thin thermoplastic resin foam film. Accordingly, it is possible to provide materials satisfying the requirements for light-weighted thin and high-rigidity parts that are demanded in the trend toward reduction in size and increase in performance of portable communication terminals such as cellular phones.

1. A process for producing a thermoplastic resin foam film, having a step of cutting a thermoplastic resin foam, characterized in that, in the step of cutting a thermoplastic resin foam, the thermoplastic resin foam is cut intermittently, as at least one of the thermoplastic resin foam and a blade is moved reciprocally and the thermoplastic resin foam and the blade are brought into contact with each other at least in the path of forward or backward movement.

2. The process for producing a thermoplastic resin foam film according to claim 1, wherein, in the step of cutting a thermoplastic resin foam, a thermoplastic resin foam having a certain thickness is cut, as the thermoplastic resin foam is fed by a certain thickness and the thermoplastic resin foam and the blade are brought into contact with each other at least in the path of forward or backward movement.

3. The process for producing a thermoplastic resin foam film according to claim 1, wherein the thermoplastic resin foam is cut into a thin film and the thin film is further flattened, as it is heated to a temperature in the range of the thermoplastic resin glass transition temperature −30° C. or higher and the glass transition temperature or less.

4. A thermoplastic resin foam film, having a density of 100 kg/m³ or more and 500 kg/m³ or less, a thickness of 0.1 mm or more and 1.0 mm or less and, a compressive strength at 10% compression of 0.8 MPa or more.

5. The thermoplastic resin foam film according to claim 4, having a thickness of 0.1 mm or more and 0.4 mm or less.

6. The thermoplastic resin foam film according to claim 4, wherein the glass transition temperature of the thermoplastic resin is 105° C. or higher.

7. The thermoplastic resin foam film according to claim 4, wherein the thermoplastic resin is a styrenic resin.

8. A laminate foam film, comprising the thermoplastic resin foam film according to claim 4 and an aluminum foil laminated at least on one face thereof.
